(19) United States
(12) Patent Application Publication
(10) Pub. No.: US 2025/0026688 A1
(43) Pub. Date: Jan. 23, 2025

(54) CUBIC BORON NITRIDE SINTERED BODY AND COATED CUBIC BORON NITRIDE SINTERED BODY

(71) Applicant: TUNGALOY CORPORATION, Fukushima (JP)

(72) Inventors: Takeru SAKAMOTO, Iwaki-shi (JP); Sho YOKOSHI, Iwaki-shi (JP)

(73) Assignee: TUNGALOY CORPORATION, Fukushima (JP)

(21) Appl. No.: 18/766,930

(22) Filed: Jul. 9, 2024

(30) Foreign Application Priority Data
Jul. 21, 2023 (JP) 2023-118933

(51) Int. Cl. C04B 35/5831; C04B 35/58; C04B 41/81

(52) U.S. Cl. CPC C04B 35/5831; C04B 35/58071; C04B 41/81; C04B 2235/3813; C04B 2235/386; C04B 2235/762

(57) ABSTRACT

A cubic boron nitride sintered body including cubic boron nitride and a binder phase, wherein content ratios of the cubic boron nitride and the binder phase are each in a specific range, the binder phase contains a Ti compound phase, an Al compound phase, and a W element-containing phase, content ratios of the Ti compound phase, the Al compound phase, and the W element-containing phase are each in a specific range, the W element-containing phase contains at least one selected from the group consisting of W₂B and WB, and I₂/I₁, which is a ratio between an X-ray diffraction peak intensity of a (111) plane of the cubic boron nitride, I₁, and a sum of X-ray diffraction peak intensities of a (211) plane of W₂B and a (110) plane of WB in the binder phase, I₂, is in a specific range.

### BACKGROUND OF THE INVENTION

### Field of the Invention

The present invention relates to a cubic boron nitride sintered body and a coated cubic boron nitride sintered body.

### Description of Related Art

A cubic boron nitride sintered body contains a cubic boron nitride (hereinafter also referred to as “cBN”) and a binder phase. cBN sintered bodies containing a Ti compound have been widely used as a material of a binder phase in a tool with a cBN sintered body for the cutting processing of iron-based work materials such as steel and cast iron. This is because cBN sintered bodies containing a Ti compound have low affinity with iron-based work materials, and are excellent in reaction wear resistance.

Accordingly, various cBN sintered bodies containing a Ti compound have been recently proposed. For example, International Publication No. WO2020/175598 proposes a cBN-based ultra-high-pressure sintered body containing cBN particles and a binder phase, wherein the binder phase contains at least one of nitrides or oxides of Al or nitrides, carbides, or carbonitrides of Ti, and 0.1 to 5.0 volume % of metal borides having an average particle size of 20 to 300 nm are dispersed, the metal borides include a metal boride (B) in which the metal component includes at least one of Nb, Ta, Cr, Mo, and W but does not include Ti, and a metal boride (A) in which the metal component is Ti alone, and the ratio Vb/Va is 0.1 to 1.0, where Va denotes the proportion (volume %) of the metal boride (A), which contains Ti alone as the metal component, and Vb denotes the proportion (volume %) of the metal boride (B), which contains at least one of Nb, Ta, Cr, Mo, and W as the metal component but does not contain Ti.

Furthermore, for example, Patent Publication JP-A-2014-083664 proposes a cubic boron nitride-based ultra-high-pressure sintered body cutting tool, characterized by including, as a tool base, a cubic boron nitride-based ultra-high-pressure sintered body containing cubic boron nitride particles, a binder phase, a Ti boride phase, and a W boride phase, wherein the average particle size of the cubic boron nitride particles is 0.5 to 3.5 μm and the cubic boron nitride particle content is 40 to 75 volume %, a fine Ti boride phase having an average particle size of 50 to 500 nm and a fine W boride phase having an average particle size of 50 to 500 nm are distributed in a dispersed manner in the binder phase, the sum total of the amounts of production of the fine Ti boride phase and W boride phase is 5 to 15 volume % of the binder phase, at least one or more of nitrides or oxides of Al occupy 15 to 35 volume % of the binder phase, at least one or more of nitrides, carbides, borides, or carbonitrides of Ti and inevitable impurities occupy the rest, and the relationship:

0.5≤(amount of production of W boride phase)/(amount of production of Ti boride phase)≤1.0

is satisfied.

### SUMMARY

### Technical Problem

However, the cubic boron nitride sintered bodies containing a Ti compound have low thermal conductivity and low toughness, leaving room for improvement.

High efficiency is required for recent cutting processing, and high speed, high feeding speed, and deeper cutting depth are remarkably required for the recent cutting processing. Accordingly, it is required in the recent cutting processing to improve the fracture resistance and wear resistance of tools more than before.

In such a background, the cBN-based ultra-high-pressure sintered body disclosed in International Publication No. WO2020/175598 is insufficient in the thermal conductivity of the cBN sintered body, and has room for improvement in wear resistance. The cubic boron nitride-based ultra-high-pressure sintered body cutting tool disclosed in Patent Publication JP-A-2014-083664 contains large proportions of Al₂O₃, which is poor in thermal conductivity, and/or AlN, which is poor in mechanical strength, in the binder phase, hence leaving room for improvement in wear resistance and/or fracture resistance.

The present invention has an object to provide a cubic boron nitride sintered body and a coated cubic boron nitride sintered body capable of extending the tool life by having excellent wear resistance and fracture resistance.

### Solution to Problem

The present inventors have conducted studies about the extension of tool life and have accordingly found that the wear resistance and the fracture resistance thereof can be improved if a cubic boron nitride sintered body has a specific constitution, and as a result, the tool life can be extended. Finally, the present inventors have completed the present invention based on such findings.

The gist of the present invention is as set forth below.
[1]

A cubic boron nitride sintered body comprising cubic boron nitride and a binder phase, wherein
a content ratio of the cubic boron nitride is 10.0 volume % or more and 60.0 volume % or less and a content ratio of the binder phase is 40.0 volume % or more and 90.0 volume % or less based on 100.0 volume % of the entire cubic boron nitride sintered body,
the binder phase includes a Ti compound phase, an Al compound phase, and a W element-containing phase,
a content ratio of the Ti compound phase is 60.0 volume % or more and 92.0 volume % or less, a content ratio of the Al compound phase is more than 0.0 volume % and less than 15.0 volume %, and a content ratio of the W element-containing phase is 5.0 volume % or more and 30.0 volume % or less based on 100.0 volume % of the entire binder phase,
the W element-containing phase contains at least one selected from the group consisting of W₂B and WB, and
I₂/I₁ is 0.03 or more and 0.60 or less, where I₁ denotes an X-ray diffraction peak intensity of a (111) plane of the cubic boron nitride, and I₂ denotes a sum of X-ray diffraction peak intensities of a (211) plane of W₂B and a (110) plane of WB in the binder phase.
[2]

The cubic boron nitride sintered body according to [1], wherein I₃/I₁ is 0.03 or less, where I₃ denotes an X-ray diffraction peak intensity of a (101) plane of WB₂ in the binder phase.
[3]

The cubic boron nitride sintered body according to [1] or [2], wherein I₄/I₂ is 0.50 or more and 0.95 or less, where I₄ denotes an X-ray diffraction peak intensity of a (211) plane of WB₂ in the binder phase.
[4]

The cubic boron nitride sintered body according to any one of [1] to [3], wherein an average thickness λ of the W element-containing phase is 0.03 μm or more and 0.12 μm or less.
[5]

The cubic boron nitride sintered body according to any one of [1] to [4], wherein
the Ti compound phase contains TiB₂, and
I₅/I₁ is 0.07 or more and 0.55 or less, where I₅ denotes an X-ray diffraction peak intensity of a (101) plane of TiB₂ in the binder phase.
[6]

The cubic boron nitride sintered body according to any one of [1] to [5], wherein
the W element-containing phase contains Co element, and
a content ratio of Co element based on a total content ratio of W element and Co element is 5 atom % or more and less than 50 atom % in the W element-containing phase.
[7]

A coated cubic boron nitride sintered body comprising the cubic boron nitride sintered body according to any one of [1] to [6] and a coating layer formed on a surface of the cubic boron nitride sintered body, wherein
an average thickness of the entire coating layer is 0.5 μm or more and 6.0 μm or less.

### Advantageous Effects of Invention

According to the present invention, a cubic boron nitride sintered body and a coated cubic boron nitride sintered body capable of extending the tool life by having excellent wear resistance and fracture resistance can be provided.

### BRIEF DESCRIPTION OF DRAWINGS

FIG. 1 shows Table 1.

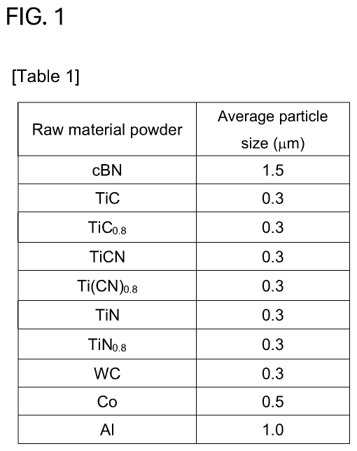

FIG. 2 shows Table 2.

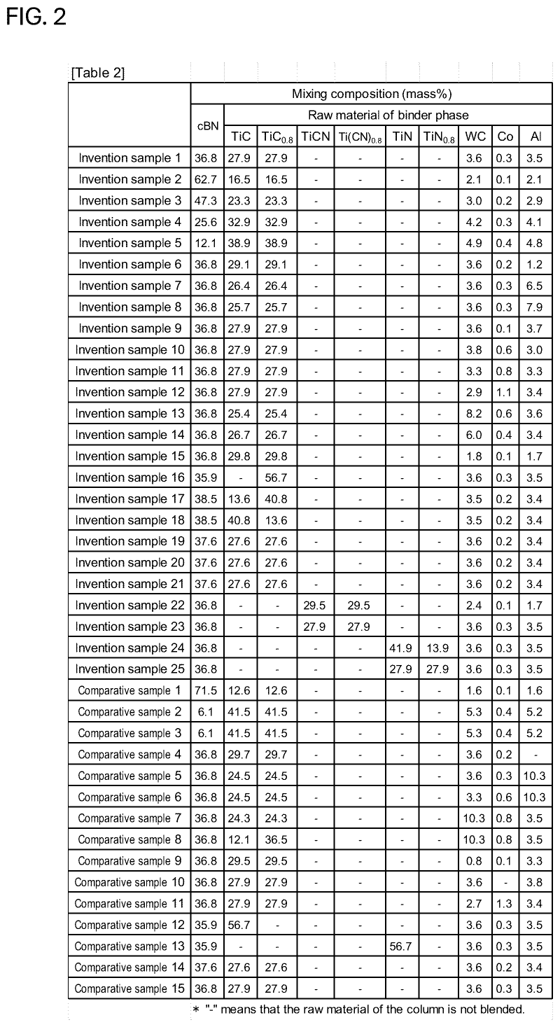

FIG. 3 shows Table 3.

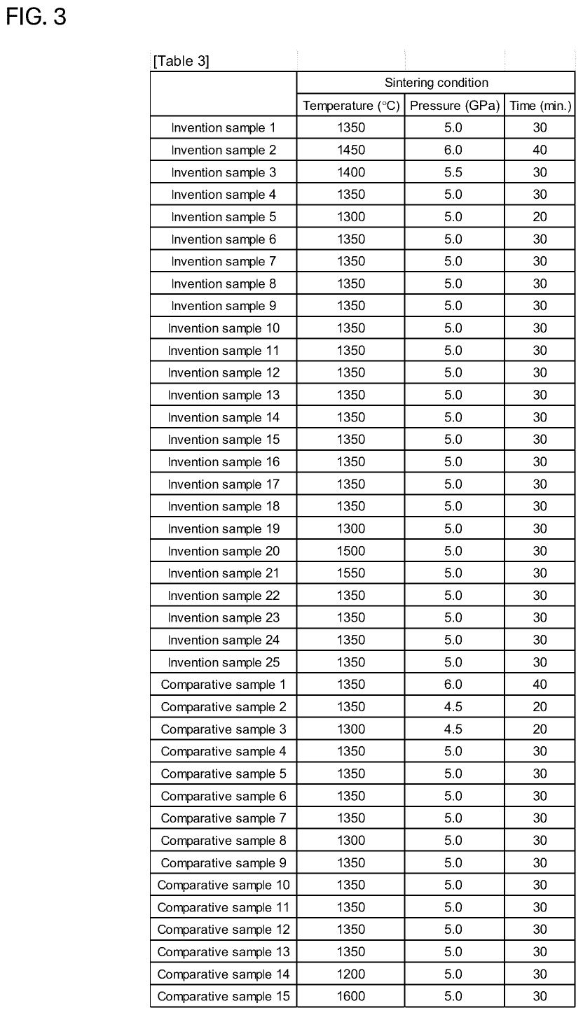

FIG. 4 shows Table 4.

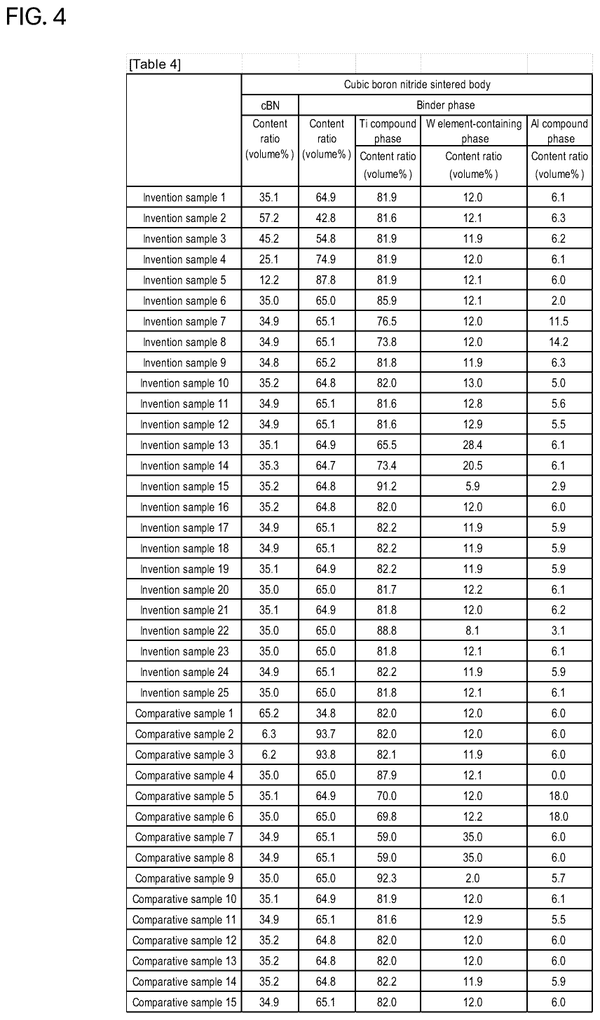

FIG. 5 shows Table 5.

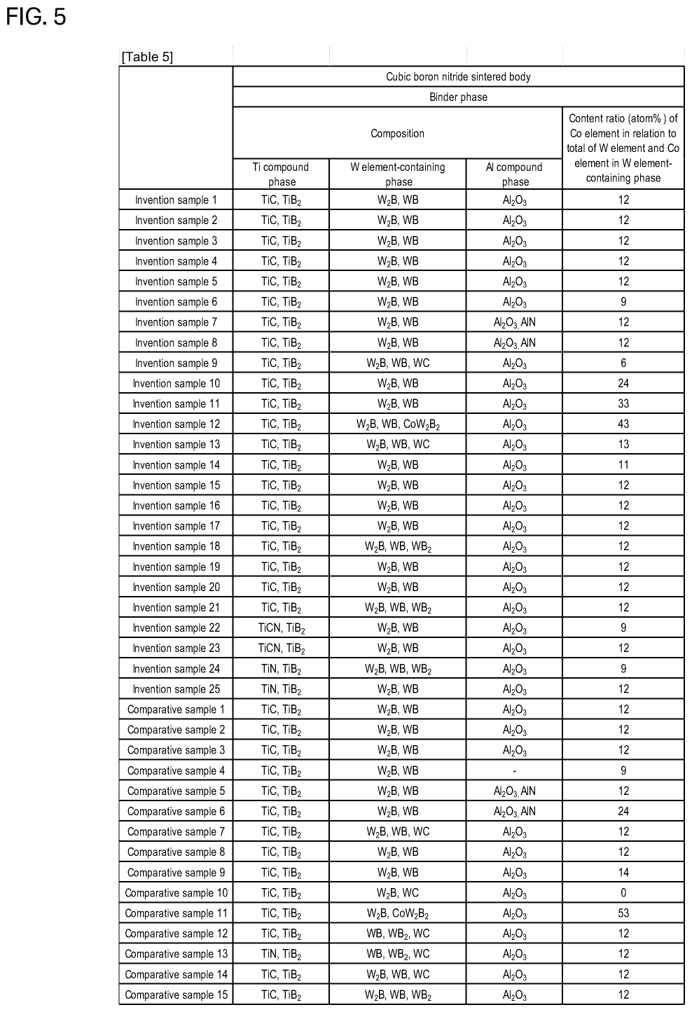

FIG. 6 shows Table 6.

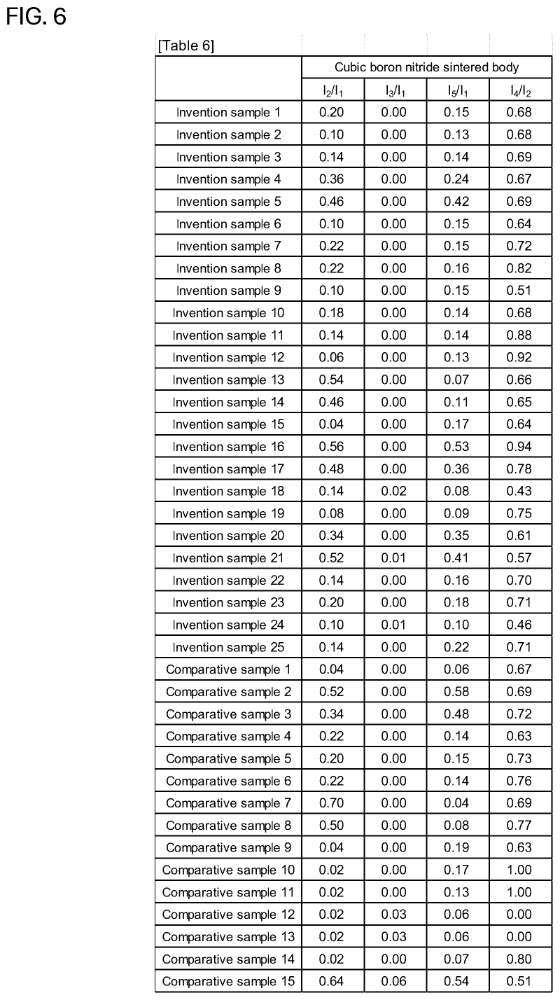

FIG. 7 shows Table 7.

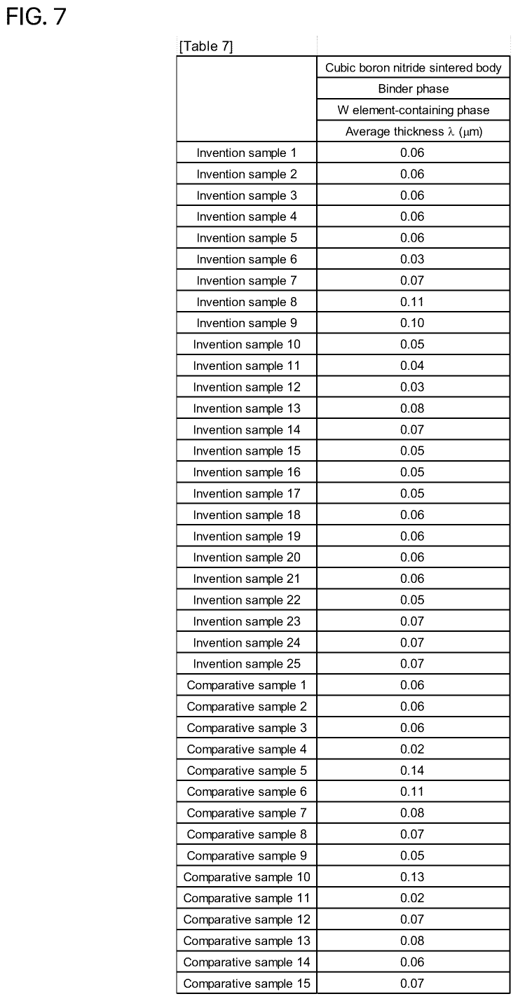

FIG. 8 shows Table 8.

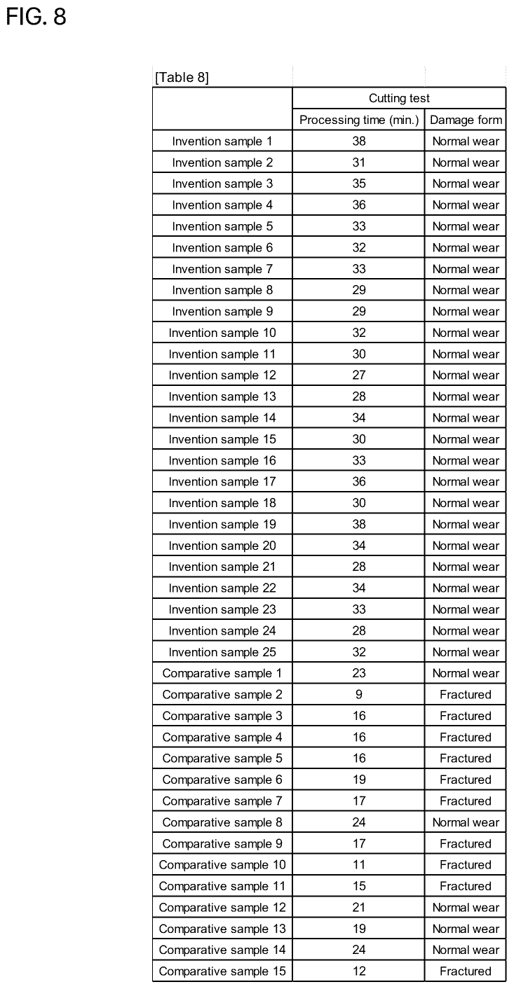

FIG. 9 shows Table 9.

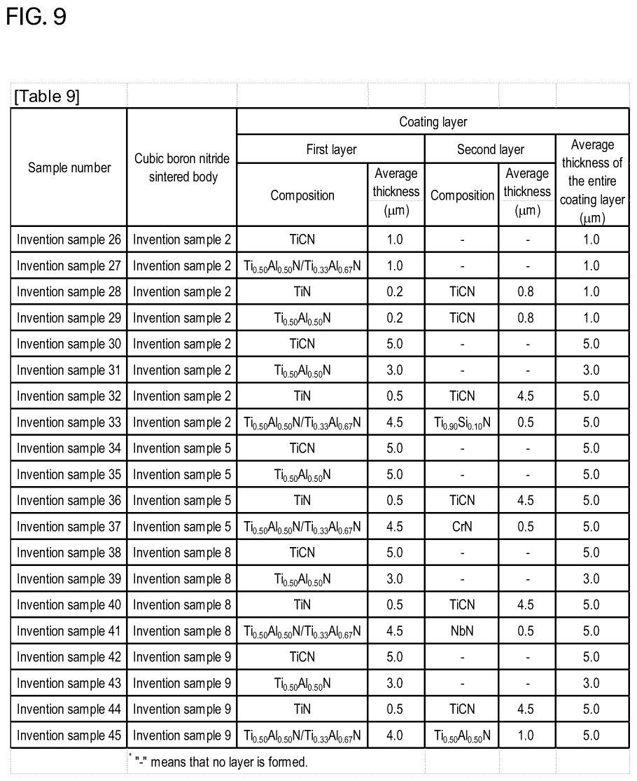

FIG. 10 shows Table 10.

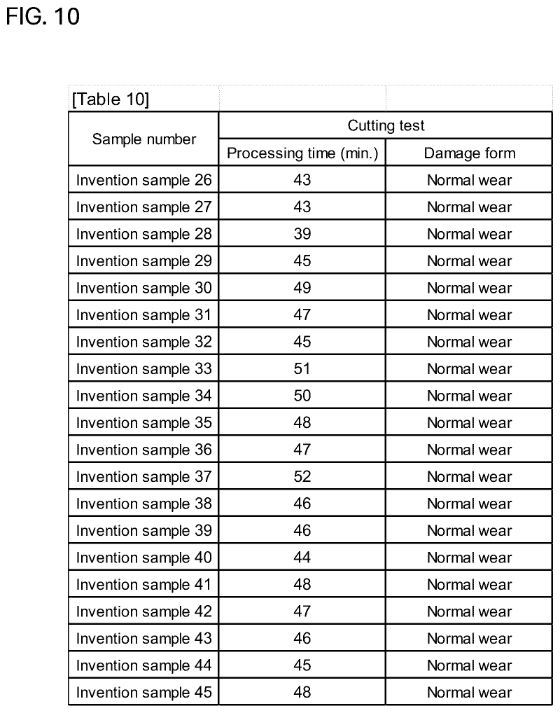

### DETAILED DESCRIPTION

An embodiment for carrying out the present invention (hereinafter simply referred to as the “present embodiment”) will hereinafter be described in detail. However, the present invention is not limited to the present embodiment described below. Various modifications may be made to the present invention without departing from the gist of the invention.

The cBN sintered body according to the present embodiment is a cBN sintered body including cBN and a binder phase, wherein a content ratio of the CBN is 10.0 volume % or more and 60.0 volume % or less and a content ratio of the binder phase is 40.0 volume % or more and 90.0 volume % or less based on 100.0 volume % of the entire cBN sintered body, the binder phase includes a Ti compound phase, an Al compound phase, and a W element-containing phase, a content ratio of the Ti compound phase is 60.0 volume % or more and 92.0 volume % or less, a content ratio of the Al compound phase is more than 0.0 volume % and less than 15.0 volume %, and a content ratio of the W element-containing phase is 5.0 volume % or more and 30.0 volume % or less based on 100.0 volume % of the entire binder phase, the W element-containing phase contains at least one selected from the group consisting of W₂B and WB, and I₂/I₁ is 0.03 or more and 0.60 or less, where I₁ denotes an X-ray diffraction peak intensity of a (111) plane of the cBN, and I₂ denotes a sum of X-ray diffraction peak intensities of a (211) plane of W₂B and a (110) plane of WB in the binder phase.

The cBN sintered body according to the present embodiment with such a constitution can improve the wear resistance and fracture resistance and, as a result, can extend the tool life.

The detailed reason why the cBN sintered body according to the present embodiment provides a tool with an extended tool life, improved wear resistance, and improved fracture resistance is not clear, but the present inventors consider the reason as follows. However, the reason is not limited thereto. That is, since the content ratio of the cBN is 10.0 volume % or more based on 100.0 volume % of the entire cBN sintered body in the cBN sintered body according to the present embodiment, the content ratio of the cBN, which is excellent in mechanical strength, becomes high, and therefore, the cBN sintered body according to the present embodiment is excellent primarily in fracture resistance. Meanwhile, since the content ratio of the cBN is 60.0 volume % or less in the cBN sintered body according to the present embodiment, the content ratio of the cBN, which is poor in reaction resistance to iron, is low, and therefore, the cBN sintered body according to the present embodiment is excellent primarily in wear resistance. Furthermore, since the content ratio of the binder phase is 40.0 volume % or more in the cBN sintered body according to the present embodiment, the content ratio of the cBN, which is poor in reaction resistance to iron, becomes relatively low, and therefore, the cBN sintered body according to the present embodiment is excellent primarily in wear resistance. Meanwhile, the content ratio the binder phase is 90.0 volume % or less in the cBN sintered body according to the present embodiment, the content ratio of the cBN, which is excellent in mechanical strength, becomes relatively high, and therefore, the cBN sintered body according to the present embodiment is excellent primarily in fracture resistance. Furthermore, since the content ratio of the Ti compound phase is 60.0 volume % or more based on 100.0 volume % of the entire binder phase in the cBN sintered body according to the present embodiment, the reaction resistance to iron is improved, and therefore, the cBN sintered body according to the present embodiment is excellent primarily in wear resistance. Meanwhile, since the content ratio of the Ti compound phase is 92.0 volume % or less in the cBN sintered body according to the present embodiment, the thermal conductivity is improved, and therefore, the cBN sintered body according to the present embodiment is excellent primarily in wear resistance. Furthermore, the content ratio of the Al compound phase is more than 0.0 volume % based on 100.0 volume % of the entire binder phase in the cBN sintered body according to the present embodiment, the sinterability are improved, and therefore, the cBN sintered body according to the present embodiment is excellent primarily in fracture resistance. Meanwhile, since the content ratio of the Al compound phase is less than 15.0 volume % in the cBN sintered body according to the present embodiment, the content ratio of an Al compound poor in thermal conductivity (for example, Al₂O₃) and/or the content ratio of an Al compound poor in mechanical strength (for example, AlN) become small, and therefore, the wear resistance and/or fracture resistance is excellent. Furthermore, since the content ratio of the Al compound phase is less than 15.0 volume %, the formation of an aggregated structure of the W-containing phase can be prevented and moreover the resulting homogeneous distribution of the W-containing phase in the binder phase improves the thermal conductivity of the cBN sintered body, and therefore, the cBN sintered body according to the present embodiment is excellent primarily in wear resistance. Furthermore, since the content ratio of the W element-containing phase is 5.0 volume % or more based on 100.0 volume % of the entire binder phase in the cBN sintered body according to the present embodiment, the thermal conductivity is improved, and therefore, the cBN sintered body according to the present embodiment is excellent primarily in wear resistance. Meanwhile, since the content ratio of the W element-containing phase is 30.0 volume % or less, the hardness is improved, and therefore, the cBN sintered body according to the present embodiment is excellent primarily in wear resistance. Furthermore, since the W element-containing phase contains at least one selected from the group consisting of W₂B and WB in the cBN sintered body according to the present embodiment, and I₂/I₁ is 0.03 or more, where I₁ denotes the X-ray diffraction peak intensity of a (111) plane of the cBN, and I₂ denotes the sum of the X-ray diffraction peak intensities of a (211) plane of W₂B and a (110) plane of WB in the binder phase, the thermal conductivity is improved, and therefore, the cBN sintered body according to the present embodiment is excellent primarily in wear resistance. Meanwhile, since I₂/I₁ is 0.60 or less in the cBN sintered body according to the present embodiment, the toughness is improved, and therefore, the cBN sintered body according to the present embodiment is improved primarily in fracture resistance. A cBN sintered body according to the present embodiment can provide a tool with an extended life, improved wear resistance, and improved fracture resistance due to these effects combined together.

The cBN sintered body according to the present embodiment includes cBN and a binder phase. The content ratio of the cBN is 10.0 volume % or more and 60.0 volume % or less, and the content ratio of the binder phase is 40.0 volume % or more and 90.0 volume % or less. Note that the total content ratio of the cBN and the binder phase is 100.0 volume % in the cBN sintered body according to the present embodiment.

Since the content ratio of the cBN is 10.0 volume % or more in the cBN sintered body according to the present embodiment, the content ratio of the cBN, which is excellent in mechanical strength, becomes high, and therefore, the fracture resistance is excellent. Meanwhile, since the content ratio of the CBN is 60.0 volume % or less in the cBN sintered body according to the present embodiment, the content ratio of the cBN, which is poor in reaction resistance to iron, is low, and therefore, the wear resistance is excellent. From a similar point of view, the content ratio of the cBN is preferably 12.2 volume % or more and 57.2 volume % or less, and more preferably 25.1 volume % or more and 45.2volume % or less.

Furthermore, since the content ratio of the binder phase is 40.0 volume % or more in the cBN sintered body according to the present embodiment, the content ratio of the cBN, which is poor in reaction resistance to iron, becomes relatively low, and therefore, the wear resistance is excellent. Meanwhile, since the content ratio of the binder phase is 90.0 volume % or less in the cBN sintered body according to the present embodiment, the content ratio of the cBN, which is excellent in mechanical strength, becomes relatively high, and therefore, the fracture resistance is excellent. From a similar point of view, the content ratio of the binder phase is preferably 42.8 volume % or more and 87.8 volume % or less, and more preferably 54.8 volume % or more and 74.9 volume % or less.

In the cBN sintered body according to the present embodiment, th content ratios (volume %) of the cBN and the binder phase can be determined by photographing an arbitrary cross-section with a scanning electron microscope (SEM) and analyzing the photographed SEM photograph using commercially available image analysis software. Specifically, the content ratios can be determined by a method disclosed in the Examples described below.

In the cBN sintered body according to the present embodiment, the binder phase includes a Ti compound phase, an Al compound phase, and a W element-containing phase.

In the present embodiment, the content ratio of the Ti compound phase is 60.0 volume % or more and 92.0 volume % or less based on 100.0 volume % of the entire binder phase. Since the content ratio of the Ti compound phase is 60.0 volume % or more in the cBN sintered body according to the present embodiment, the reaction resistance to iron is improved, and therefore, the wear resistance is excellent. Meanwhile, since the content ratio of the Ti compound phase is 92.0 volume % or less in the cBN sintered body according to the present embodiment, the thermal conductivity is improved, and therefore, the wear resistance is excellent. From a similar point of view, the content ratio of the Ti compound phase is preferably 65.5 volume % or more and 91.2 volume % or less, and more preferably 73.4 volume % or more and 88.8 volume % or less.

In the cBN sintered body according to the present embodiment, the Ti compound phase preferably contains at least one selected from the group consisting of TiC, TiCN, TiN, and TiB₂. When the Ti compound phase contains such a compound, the reaction wear resistance tends to be excellent. From a similar point of view, the Ti compound phase preferably contains at least one selected from the group consisting of TiC, TiCN, and TiB₂, and more preferably contains at least one selected from the group consisting of TiC and TiB₂.

In the cBN sintered body according to the present embodiment, the content ratio of the Al compound phase is more than 0.0 volume % and less than 15.0 volume % based on 100.0 volume % of the entire binder phase. Since the content ratio of the Al compound phase is more than 0.0 volume % in the cBN sintered body according to the present embodiment, the sinterability are improved, and therefore, the fracture resistance is excellent. Meanwhile, since the content ratio of the Al compound phase is less than 15.0 volume % in the cBN sintered body according to the present embodiment, the content ratio of an Al compound poor in thermal conductivity (for example, Al₂O₃) and/or the content ratio of an Al compound poor in mechanical strength (for example, AlN) become small, and therefore, the wear resistance and/or fracture resistance is excellent. Furthermore, since the content ratio of the Al compound phase is less than 15.0 volume %, the formation of an aggregated structure of the W-containing phase can be prevented and moreover the resulting homogeneous distribution of the W-containing phase in the binder phase improves the thermal conductivity of the cBN sintered body, and therefore, the wear resistance is excellent. From a similar point of view, the content ratio of the Al compound phase is preferably 2.0 volume % or more and 14.2 volume % or less, and more preferably 2.9 volume % or more and 11.5 volume % or less.

In the cBN sintered body according to the present embodiment, the Al compound phase preferably contains at least one selected from the group consisting of Al₂O₃, AlN, and AlB₂. When the Al compound phase contains such a compound, the sinterability of the cBN sintered body are improved, and therefore, the fracture resistance tends to be excellent. From a similar point of view, the Al compound phase preferably contains at least one selected from the group consisting of Al₂O₃ and AlN, and more preferably contains Al₂O₃.

In the cBN sintered body according to the present embodiment, the content ratio of the W element-containing phase is 5.0 volume % or more and 30.0 volume % or less based on 100.0 volume % of the entire binder phase. Since the content ratio of the W element-containing phase is 5.0 volume % or more in the cBN sintered body according to the present embodiment, the thermal conductivity is improved, and therefore, the wear resistance is excellent. Meanwhile, the content ratio of the W element-containing phase is 30.0 volume % or less in the cBN sintered body according to the present embodiment, the hardness is improved, and therefore, the wear resistance is excellent. From a similar point of view, the content ratio of the W element-containing phase is preferably 5.9 volume % or more and 28.4 volume % or less, and more preferably 8.1 volume % or more and 20.5 volume % or less.

In the present embodiment, the content ratios (volume %) of the Ti compound phase, the Al compound phase, and the W element-containing phase in the binder phase can be determined by the method described in the Examples mentioned below.

In the cBN sintered body according to the present embodiment, the W element-containing phase may contain, in addition to W₂B and WB described above, at least one selected from the group consisting of metal, a carbide, a nitride, and a boride of W, and a solid solution of them; and an alloy, a carbide, a nitride, and a boride each containing W and at least one selected from the group consisting Co, Al, Ti, Ni, V, Cr, Zr, Nb, Mo, Hf, and Ta, and a solid solution of them. When the W element-containing phase contains such a material, the interparticle binding strength of the cBN sintered body is improved, and therefore, the fracture resistance tends to be excellent.

In the cBN sintered body according to the present embodiment, the W element-containing phase preferably contains Co element. When the W element-containing phase contains Co element, the interparticle binding strength of the cBN sintered body is improved and moreover the toughness is also improved, and therefore, the fracture resistance tends to be excellent.

In the present embodiment, if a plurality of W element-containing phases is present, the meaning of “the W element-containing phase contains Co element” encompasses not only the case that all the W element-containing phases contain Co element but also the case that some phases of the W element-containing phases contain Co element.

Non-limiting examples of a compound containing W element and Co element include CoW₂B₂.

When the W element-containing phase contains Co element, the content ratio of Co element based on the total content ratio of W element and Co element is preferably 5 atom % or more and less than 50 atom %. Since the content ratio of Co element based on the total content ratio of W element and Co element is 5 atom % or more in the W element-containing phase in the cBN sintered body according to the present embodiment, the toughness is improved, and therefore, the fracture resistance tends to be much better. Meanwhile, the content ratio of Co element based on the total content ratio of W element and Co element is less than 50 atom % in the W element-containing phase in the cBN sintered body according to the present embodiment, the hardness is improved, and therefore, the wear resistance tends to be much better. From a similar point of view, the content ratio of Co element based on the total content ratio of W element and Co element is preferably 6 atom % or more and 43 atom % or less, and more preferably 9 atom % or more and 33 atom % or less.

In the present embodiment, the content ratio (atom %) of Co element in the W element-containing phase can be determined by the method described in the Examples mentioned below.

In the cBN sintered body according to the present embodiment, the average thickness λ of the W element-containing phase is preferably 0.03 μm or more and 0.12 μm or less. Since the average thickness λ of the W element-containing phase is 0.03 um or more in the cBN sintered body according to the present embodiment, the toughness of the binder phase is improved, and therefore, the fracture resistance tends to be much better. Meanwhile, since the average thickness λ of the W element-containing phase is 0.12 μm or less in the cBN sintered body according to the present embodiment, the cBN sintered body according to the present embodiment exhibits less aggregated structure of the W element-containing phase and homogeneous distribution thereof in the binder phase to result in improved thermal conductivity, and therefore, the wear resistance tends to be much better. From a similar point of view, the average thickness λ of the W element-containing phase is preferably 0.04 μm or more and 0.11 μm or less, and more preferably 0.05 μm or more and 0.10 μm or less.

In the present embodiment, the average thickness λ of the W element-containing phase can be determined by the method described in the Examples mentioned below.

In the cBN sintered body according to the present embodiment, the W element-containing phase contains at least one selected from the group consisting of W₂B and WB, and I₂/I₁ is 0.03 or more and 0.60 or less, where I₁ denotes the X-ray diffraction peak intensity of a (111) plane of the cBN, and I₂ denotes the sum of the X-ray diffraction peak intensities of a (211) plane of W₂B and a (110) plane of WB in the binder phase. Since I₂/I₁ is 0.03 or more in the cBN sintered body according to the present embodiment, the thermal conductivity is improved, and therefore, the wear resistance is excellent. Meanwhile, since I₂/I₁ is 0.60 or less in the cBN sintered body according to the present embodiment, the toughness is improved, and therefore, the fracture resistance is improved. From a similar point of view, I₂/I₁ is preferably 0.04 or more and 0.56 or less, more preferably 0.06 or more and 0.54 or less, and further preferably 0.08 or more and 0.52 or less.

In the cBN sintered body according to the present embodiment, I₃/I₁ is preferably 0.03 or less, where I₁ denotes the X-ray diffraction peak intensity of a (111) plane of the cBN, and I₃ denotes the X-ray diffraction peak intensity of a (101) plane of WB₂ in the binder phase. Since I₃/I₁ is 0.03 or less in the cBN sintered body according to the present embodiment, the cBN sintered body according to the present embodiment exhibits reduced formation of hexagonal W boride, which has low mechanical strength, and the toughness is improved, and therefore, the fracture resistance tends to be much better. From a similar point of view, I₃/I₁ is preferably 0.02 or less, more preferably 0.01 or less, and further preferably 0.00.

In the cBN sintered body according to the present embodiment, the W-containing phase preferably contains substantially no WB₂.

In the present embodiment, the wording “containing substantially no WB₂” means that WB₂ is not detected in an X-ray diffraction measurement of the binder phase.

In the cBN sintered body according to the present embodiment, I₄/I₂ is preferably 0.50 or more and 0.95 or less, where I₂ denotes the sum of the X-ray diffraction peak intensities of a (211) plane of W₂B and a (110) plane of WB in the binder phase, and I₄ denotes the X-ray diffraction peak intensity of a (211) plane of W₂B in the binder phase. Since I₄/I₂ is 0.50 or more in the cBN sintered body according to the present embodiment, the thermal conductivity is improved, and therefore, the wear resistance tends to be much better. Meanwhile, since I₄/I₂ is 0.95 or less in the cBN sintered body according to the present embodiment, the hardness is improved, and therefore, the wear resistance tends to be much better. From a similar point of view, I₄/I₂ is preferably 0.51 or more and 0.94 or less, and more preferably 0.57 or more and 0.92 or less.

In the cBN sintered body according to the present embodiment, the Ti compound phase contains TiB₂, and I₅/I₁ is preferably 0.07 or more and 0.55 or less, where I₁ denotes the X-ray diffraction peak intensity of a (111) plane of the cBN, and I₅ denotes the X-ray diffraction peak intensity of a (101) plane of TiB₂ in the binder phase. Since the Ti compound phase contains TiB₂ and I₅/I₁ is 0.07 or more in the cBN sintered body according to the present embodiment, the binding strength between the cBN and the binder phase is improved, and therefore, the fracture resistance tends to be much better. Meanwhile, since I₅/I₁ is 0.55 or less in the cBN sintered body according to the present embodiment, the proportion of TiB₂, which has low mechanical strength, is low, and therefore, the toughness is improved and the fracture resistance tends to be much better. From a similar point of view, I₅/I₁ is preferably 0.08 or more and 0.53 or less, and more preferably 0.09 or more and 0.42 or less.

In the present embodiment, the composition of a binder phase can be identified using a commercially available X-ray diffractometer. For example, when an X-ray diffraction measurement is performed, using an X-ray diffractometer (product name “SmartLab”) manufactured by Rigaku Corporation, by means of a 2θ/θ focusing optical system with Cu-Kα radiation under the following conditions, the composition of the binder phase can be identified. Here, the measurement conditions may be as follow:
Output: 45 kV, 200 mA,
Incident-side Soller slit: 5°,
Divergence vertical slit: ⅔°,
Divergence vertical restriction slit: 5 mm,
Scattering slit ⅔°,
Light-receiving side Soller slit: 5°,
Light reception slit: 0.3 mm,
Sampling width: 0.02°,
Scan speed: 1°/min
2θ measurement range: 30° to 90°.

In the present embodiment, the binder phase composition can be determined by the methods described in the Examples mentioned below.

In the present embodiment, the X-ray diffraction peak intensity of the cBN and each compound in the binder phase can be identified using a commercially available X-ray diffractometer. For example, the X-ray diffraction peak intensity can be measured using an X-ray diffractometer (product name “SmartLab”) manufactured by Rigaku Corporation. The measurement conditions are, for example, the same as those in the identification method described above for the composition of the binder phase.

The cBN sintered body according to the present embodiment may inevitably include impurities. Non-limiting examples of impurities include lithium included in raw material powder. The content ratio of the inevitable impurities is normally 1 mass % or less based on the entire cBN sintered body. Accordingly, inevitable impurities hardly affect the characteristic values of the cBN sintered body.

The coated cBN sintered body according to the present embodiment includes the cBN sintered body mentioned above and a coating layer formed on a surface of the cBN sintered body.

The coating layer formed on a surface of the cBN sintered body further improves the wear resistance of the cBN sintered body. The coating layer preferably includes an element of at least one selected from the group consisting of Ti, Zr, Hf, V, Nb, Ta, Cr, Mo, W, Al, and Si and an element of at least one selected from the group consisting of C, N, O, and B. The coating layer may have a single-layer structure or a laminated structure including two or more layers. When the coating layer has such structures, the coated cBN sintered body according to the present embodiment shows further improved wear resistance.

A method of manufacturing a coating layer in a coated cBN sintered body according to the present embodiment is not particularly limited, and examples of such methods include chemical vapor deposition methods and physical vapor deposition methods, such as an ion plating method, an arc ion plating method, a sputtering method, and an ion mixing method. Among them, arc ion plating methods are still preferred because further better adhesiveness between the coating layer and the cBN sintered body can be provided.

Non-limiting examples of compounds forming the coating layer include TiN, TiC, TiCN, TiAlN, TiSiN, CrAlN, and the like. The coating layer may have a structure in which multiple layers, each having a different composition, are laminated in an alternating manner. In this case, the average thickness of each of the single layers is, for example, 5 nm or more and 500 nm or less.

The average thickness of the entire coating layer is preferably 0.5 μm or more and 6.0 μm or less. The coated cBN sintered body of the present embodiment tends to show improved wear resistance when the average thickness of the entire coating layer is 0.5 μm or more. In contrast, the coated cBN sintered body tends to suppress the occurrence of fractures due to peeling when the average thickness of the entire coating layer is 6.0 μm or less. From a similar point of view, the average thickness of the entire coating layer is preferably 1.0 μm or more and 5.5 μm or less and more preferably 1.0 μm or more and 5.0 μm or less.

The thickness of each layer that constitutes the coating layer and the thickness of the entire coating layer can be measured from a cross-sectional structure of the coated cBN sintered body using an optical microscope, a SEM, a transmission electron microscope (TEM), or the like. It should be noted that, as to the average thickness of each layer and the average thickness of the entire coating layer in the coated cBN sintered body, in the case that the coating layer is formed by an arc ion plating method, such average thicknesses can be obtained by measuring, near the position 50 μm from the edge of a surface facing the metal evaporation source toward the center of such surface, the thickness of each layer and the thickness of the entire coating layer from each of the cross-sections at three or more locations, and calculating the average value thereof.

The composition of each layer that constitutes the coating layer can be measured from a cross-sectional structure of the coated cBN sintered body using an EDS, a wavelength-dispersive X-ray spectroscope (WDS), or the like.

The cBN sintered body or the coated cBN sintered body according to the present embodiment shows excellent wear resistance and fracture resistance, and is therefore preferably used as cutting tools and wear-resistant tools, and among them, is preferably used as cutting tools. The cBN sintered body or the coated cBN sintered body according to the present embodiment is further preferably used as cutting tools for cast iron. The tool life can be extended compared to conventional tools when the cBN sintered body or the coated cBN sintered body according to the present embodiment is used as cutting tools or wear-resistant tools.

The cBN sintered body according to the present embodiment is manufactured, for example, in the following manner.

As raw material powder, cBN powder, TiC powder, TiC_{0.8} powder, TiCN powder, Ti(CN)_{0.8} powder, TiN powder, TiN_{0.8} powder, WC powder, Co powder, and Al powder are prepared. Here, the content ratios (volume %) of the cBN and the binder phase in an obtained cBN sintered body can be controlled within the above specific ranges by appropriately adjusting the proportion of each raw material powder. In addition, the content ratios (volume %) of the Ti compound phase, the W element-containing phase, and the Al compound phase in the binder phase can be controlled within the above specific ranges by appropriately adjusting the proportion of each raw material powder. Furthermore, the content ratio of Co element based on the total content ratio of W element and Co element in the W element-containing phase can be controlled within the above specific range by appropriately adjusting the proportion of each raw material powder. Next, the prepared raw material powder is put in a ball mill cylinder together with cermet balls, a solvent, and paraffin, and then mixed.

A high-melting-point metal capsule made of Zr is filled with the raw material powder mixed with ball mills under a nitrogen atmosphere in a glove box. To remove moisture and organic components adsorbed on the surface of the filling raw material powder, vacuum heat treatment is performed with the capsule opened. After the vacuum heat treatment, the capsule is sealed, and the raw material powder filling the capsule is sintered at high temperature under high pressure. For example, the condition of high-pressure sintering is a pressure of 4.0 to 7.0 GPa, a temperature of 1250° C. to 1550° C., and a sintering time of 20 to 60 minutes.

Methods for controlling I₂/I₁, where I₁ denotes the X-ray diffraction peak intensity of a (111) plane of the cBN, and I₂ denotes the sum of the X-ray diffraction peak intensities of a (211) plane of W₂B and a (110) plane of WB in the binder phase, to the above specific range are not particularly limited, and, for example, a method for appropriately adjusting the type or the blending proportion of raw material powder or a method for appropriately adjusting the temperature during sintering raw material powder can be mentioned. Specific examples of methods for increasing I₂/I₁ include a method of decreasing the content ratio (volume %) of the cBN in the cBN sintered body, a method of increasing the content ratio (volume %) of the W-containing phase in the binder phase, a method of using a compound raw material having a nonstoichiometric atomic ratio between a metal element and a nonmetal element (TiC_{0.8}, Ti(CN)_{0.8}, or TiN_{0.8}) as a raw material of the Ti compound phase in an increased proportion, or a method of increasing the temperature during sintering the raw material powder, and a method of setting the content ratio of Co element based on the total content ratio of W element and Co element in the W element-containing phase within the range described above.

Methods for controlling I₄/I₂, where I₂ denotes the sum of the X-ray diffraction peak intensities of a (211) plane of W₂B and a (110) plane of WB in the binder phase, and I₄ denotes the X-ray diffraction peak intensity of a (211) plane of W₂B in the binder phase, to the above specific range are not particularly limited, and, for example, a method for appropriately adjusting the type or the blending proportion of raw material powder or a method for appropriately adjusting the temperature during sintering raw material powder can be mentioned. Specific examples of methods for increasing I₄/I₂ include a method of increasing the content ratio of Co element based on the total content ratio of W element and Co element in the W element-containing phase, a method of using a compound raw material having a nonstoichiometric atomic ratio between a metal element and a nonmetal element (TiC_{0.8}, Ti(CN)_{0.8}, or TiN_{0.8}) as a raw material of the Ti compound phase in an increased proportion, and a method of decreasing the temperature during sintering the raw material powder.

Methods for controlling I₃/I₁, where I₁ denotes the X-ray diffraction peak intensity of a (111) plane of the cBN, and I₃ denotes the X-ray diffraction peak intensity of a (101) plane of WB₂ in the binder phase, to the above specific range are not particularly limited, and, for example, a method for appropriately adjusting the type or the blending proportion of raw material powder or a method for appropriately adjusting the temperature during sintering raw material powder can be mentioned. Specific examples of methods for decreasing I₃/I₁ include a method of using a compound raw material having a nonstoichiometric atomic ratio between a metal element and a nonmetal element (TiC_{0.8}, Ti(CN)_{0.8}, or TiN_{0.8}) as a raw material of the Ti compound phase and a method of decreasing the temperature during sintering the raw material powder.

Examples of methods for allowing the W-containing phase in the binder phase to contain substantially no WB₂ include a method of using a compound raw material having a nonstoichiometric atomic ratio between a metal element and a nonmetal element (TiC_{0.8}, Ti(CN)_{0.8}, or TiN_{0.8}) as a raw material of the Ti compound phase in a specific amount or more and setting the temperature during sintering the raw material powder to 1500° C. or less. Specifically, for example, the W-containing phase tends to be allowed to contain substantially no WB₂ in the binder phase by setting the amount of a compound raw material having a nonstoichiometric atomic ratio between a metal element and a nonmetal element (TiC_{0.8}, Ti(CN)_{0.8}, or TiN_{0.8}) to 50 volume % or more based on 100 volume % of the total amount of raw materials of the Ti compound phase and setting the temperature during sintering the raw material powder to 1500° C. or less.

Methods for controlling I₅/I₁, where I₁ denotes the X-ray diffraction peak intensity of a (111) plane of the cBN, and I₅ denotes the X-ray diffraction peak intensity of a (101) plane of TiB₂ in the binder phase, to the above specific range are not particularly limited, and, for example, a method for appropriately adjusting the type or the blending proportion of raw material powder or a method for appropriately adjusting the temperature during sintering raw material powder can be mentioned. Specific examples of methods for increasing I₅/I₁ include a method of decreasing the content ratio (volume %) of the cBN in the cBN sintered body and a method of increasing the content ratio (volume %) of the Ti compound phase in the binder phase and a method of increasing the temperature during sintering the raw material powder.

Methods for controlling the average thickness λ (μm) of the W element-containing phase to the above specific range are not particularly limited, and, for example, a method for appropriately adjusting the type or the blending proportion of raw material powder can be mentioned. Specific examples of methods for decreasing the average thickness λ (μm) of the W element-containing phase include a method of decreasing the content ratio (volume %) of the Al compound phase in the binder phase and a method of increasing the content ratio of Co element based on the total content ratio of W element and Co element in the W element-containing phase.

If the content ratio of Co element based on the total content ratio of W element and Co element is increased in the W element-containing phase, the content ratio of CoW₂B₂ tends to increase to a degree that allows successful detection in an X-ray diffraction measurement.

A cutting tool or a wear-resistant tool including the cBN sintered body can be manufactured by processing the cBN sintered body according to the present embodiment with a wire electric discharge cutting machine or a laser cutting machine into a predetermined shape.

### EXAMPLES

Although the present invention will be described in further detail below with examples, the present invention is not limited to such examples.

### Example 1

### Preparation of Raw Material Powder

cBN powder, TiC powder, TiC_{0.8} powder, TiCN powder, Ti(CN)_{0.8} powder, TiN powder, TiN_{0.8} powder, WC powder, Co powder, and Al powder were mixed in the proportion listed in the following Table 2. The average particle size of each raw material powder was as listed in Table 1. The average particle size of the raw material powder was measured in accordance with the Fisher process (Fisher Sub-Sieve Sizer (FSSS)) disclosed in the American Society for Testing Materials (ASTM) standard B330.

### Mixing Raw Material Powder

Raw material powder was put in a ball mill cylinder together with cermet balls, hexane solvent, and paraffin, and then mixed for 6 hours.

### Filling Step and Drying Step

A high-melting-point metal capsule made of Zr (hereinafter simply referred to as the “capsule”) was filled with the mixed raw material powder under a nitrogen atmosphere in a glove box. To remove moisture and organic components adsorbed on the surface of the filling raw material powder, vacuum heat treatment was performed with the capsule opened. After the vacuum heat treatment, the capsule was sealed.

### Sintering Step

Thereafter, the raw material powder filling the capsule was sintered at high temperature under high pressure. The following Table 3 shows the condition of the high-pressure sintering.

### Analysis of SEM Image

The content ratios (volume %) of the cBN and the binder phase in the cBN sintered body obtained by high-pressure sintering was determined by analyzing a structural photograph of the cBN sintered body, which had been taken by a scanning electron microscope (SEM), using commercially available image analysis software. More specifically, the cBN sintered body was mirror-polished in a direction orthogonal to a surface thereof. Next, a backscattered electron image of the mirror-polished surface of the cBN sintered body exposed via the mirror polishing was observed using a SEM. At this time, the mirror-polished surface of the cBN sintered body was observed using the SEM via a backscattered electron image at a magnification selected so that 100 or more and 300 or less cBN particles could be covered. Using an energy-dispersive X-ray spectroscope (EDS) included with the SEM, a black region was identified as cBN, and gray and white regions were identified as binder phases. Furthermore, in the binder phase, a dark gray region was identified as the Al compound phase, a pale gray region as the Ti compound phase, and a white region as the W element-containing phase. Thereafter, a structural photograph of the above cross-section of the cBN was taken using the SEM. With commercially available image analysis software, the respective occupied areas of the cBN and the binder phase were determined from the obtained structural photograph, and the content ratios (volume %) were determined from the occupied areas. In addition, the content ratios (volume %) of the Ti compound phase, the Al compound phase, and the W element-containing phase in the binder phase were similarly calculated from the proportions of the phases to the area occupied by the binder phase in the structural photograph.

Here, a cross-section of the cBN sintered body obtained by mirror-polishing the surface of the cBN sintered body or an arbitrary cross-section thereof was set as the mirror-polished surface of the cBN sintered body. Polishing using diamond paste was adopted as the method for obtaining a mirror-polished surface of a cBN sintered body.

The composition of the binder phase was identified using an X-ray diffractometer (product name “SmartLab”) manufactured by Rigaku Corporation. Specifically, an X-ray diffraction measurement of a 2θ/θ focusing optical system using Cu-Kα ray was performed in the following condition to identify the composition of the binder phase.
Output: 45 kV, 200 mA,
Incident-side Soller slit: 5°,
Divergence vertical slit: ⅔°,
Divergence vertical restriction slit: 5 mm,
Scattering slit ⅔°,
Light-receiving side Soller slit: 5°,
Light reception slit: 0.3 mm,
Sampling width: 0.02°,
Scan speed: 1°/min
2θ measurement range: 30° to 90°.

Table 4 below shows these measurement results.

In the case that the W element-containing phase contained Co element, the content ratio (atom %) of Co element based on the total content ratio of W element and Co element was calculated as follows. First, EDS analysis was performed for the whole of an observation field that is the same as the observation field of the structural photograph of the cBN sintered body taken with the SEM in the same manner as described above to determine the content ratios (atom %) of W element and Co element contained in the cBN sintered body. From the obtained values, the content ratio (atom %) of Co element based on the total content ratio of W element and Co element was calculated. Table 5 shows the results.

### Analysis by X-Ray Diffraction (XRD)

Analysis by X-ray diffraction (XRD) was performed for the Ti compound phase, Al compound phase, and W element-containing phase included in the cBN sintered body obtained through the sintering step. Table 5 below shows the analysis results by XRD for the Ti compound phase, the Al compound phase, and the W element-containing phase. Table 5 shows only phases for which a clear peak was identified in the X-ray diffraction measurement. For the W element-containing phase, analysis with an EDS identified the presence of a phase containing both W element and Co element, except for comparative sample 10. The X-ray diffraction measurement could not identify a clear peak indicative of a phase containing both W element and Co element except for invention sample 12 and comparative sample 11, but the W element-containing phase was confirmed to contain Co element except for comparative sample 10, and CoW₂B₂ was detected in the X-ray diffraction measurement for invention sample 12 and comparative sample 11; from these results, the samples other than invention sample 12, comparative sample 10, and comparative sample 11 were inferred to at least contain CoW₂B₂ in such a proportion that did not allow successful detection in the X-ray diffraction measurement.

The X-ray diffraction peak intensity of a (111) plane of the cBN, and the X-ray diffraction peak intensities of a (211) plane of W₂B, a (110) plane of WB, a (101) plane of WB₂, and a (101) plane of TiB₂ in the binder phase were determined from the obtained X-ray diffraction patterns, and the proportions were calculated. The X-ray diffraction intensity was determined based on the peak heights. The following Table 6 shows these results.

The XRD measurement was performed, using an X-ray diffractometer (product name “SmartLab”) manufactured by Rigaku Corporation, by means of a 2θ/θ focusing optical system with Cu-Kα ray. The measurement conditions were the same as those in the identification method described above for the composition of the binder phase. The following PDF cards were referred to for identification of peaks.
CBN: No. 00-035-1365
W₂B: No. 01-089-1991
WB: No. 00-006-0541
WB₂: No. 01-089-3928
TiB₂: No. 00-035-0741

### Method for Calculating Average Thickness λ of W Element-Containing Phase

Observation of a backscattered electron image of a sectional structure and analysis with an EDS were combined for determination. A black region in a backscattered electron image of a sectional structure was identified as the cBN, a dark gray region as the Al compound phase, a pale gray region as the Ti compound phase, and a white region as the W element-containing phase. The average thickness λ (μm) of the W element-containing phase was calculated from an expression below. Table 7 shows the results.

λ=X/N_{L}

X: the ratio of the area occupied by the W element-containing phase to the area occupied by the entire binder phase in a sectional structure was determined.
N_{L}: an arbitrary straight line was drawn in the sectional structure, and the total number of regions of the W element-containing phase crossed by the straight line was divided by the total length of segments of the straight line crossing the binder phase to determine N_{L}.

### Preparation of Cutting Tool

The obtained cBN sintered body was cut out so as to correspond to the insert-shaped tool shape defined in the ISO standard CNGA 120408 using a wire electric discharge cutting machine. The cut-out cBN sintered body was joined to a cemented carbide base metal via brazing. The brazed tool was honing-processed to obtain a cutting tool.

### Cutting Test

By using the obtained cutting tools, a cutting test was performed under the following conditions.
Work material: SCM 415H carburized and hardened steel (HRC 60),
Work material shape: Round bar, φ80 mm×200 mm,
Processing method: Outer diameter cutting,
Cutting speed: 250 m/min,
Feed: 0.1 mm/rev,
Depth of cut: 0.1 mm,
Coolant: used (water-soluble coolant),
   Evaluation items: the tool life was defined as when the width of the flank wear of a tool reached 0.10 mm or when a tool was fractured, and the processing time to the tool life was measured. The damage form of a sample such that the width of the flank wear of a tool reached 0.10 mm to result in the expiration of the tool life was defined as “Normal wear”, and the damage form of a sample such that fracturing occurred to result in the expiration of the tool life was defined as “Fractured”. Table 8 shows the measurement results.

As is recognized from the results indicated in Table 8, cutting tools produced form the cBN sintered bodies of the invention samples showed better wear resistance and fracture resistance than cutting tools produced from the cBN sintered bodies of the comparative samples and showed longer tool life.

### Example 2

Next, as indicated in Table 9, ion bombardment processing was applied to the surfaces of the cBN sintered bodies of invention samples 2, 5, 8, and 9 obtained in Example 1, and coating layers were formed by an arc ion plating method. When a first layer and a second layer were formed, these layers were formed on the surface of the cBN sintered body in the stated order. The processing conditions were as described below. The compositions and average thicknesses of the coating layers were as listed in the following Table 9. For the composition of the first layer, Ti_{0.50}Al_{0.50}N/Ti_{0.33}Al_{0.67}N, layers of Ti_{0.50}Al_{0.50}N and Ti_{0.33}Al_{0.67}N each in 50 nm were alternately and repeatedly formed. At this time, the formation was performed in such a manner that the total thickness of the alternately and repeatedly formed Ti_{0.50}Al_{0.50}N/Ti_{0.33}Al_{0.67}N reached the average thickness of the first layer.

### Condition of Ion Bombardment Processing

Substrate temperature: 500° C.
Pressure: Ar gas atmosphere at 2.7 Pa
Voltage: −400 V
Current: 40 A
Time: 30 minutes

### Coating Layer Formation Condition

Substrate temperature: 500° C.
Pressure: nitrogen (N₂) gas atmosphere at 3.0 Pa (for nitride layer), or a mixed gas atmosphere of nitrogen (N₂) gas and acetylene (C₂H₂) gas at 3.0 Pa (for carbonitride layer)
Voltage: −60 V
Current: 120 A

A cutting test of a coated cBN sintered body provided with a coating layer on the surface was performed similarly to Example 1. The following Table 10 shows the results.

As is recognized from the results indicated in Table 10, the coated cBN sintered body provided with a coating layer on the surface thereof (invention samples 26 to 45) had better wear resistance than the cBN sintered body without a coating layer (invention samples 1 to 25) and showed longer tool life.

### INDUSTRIAL APPLICABILITY

The cBN sintered body and the coated cBN sintered body of the present invention can extend the tool life compared to conventional ones due to excellent wear resistance and excellent fracture resistance, and is highly industrially applicable in that point.

What is claimed is:

1. A cubic boron nitride sintered body comprising cubic boron nitride and a binder phase, wherein
a content ratio of the cubic boron nitride is 10.0 volume % or more and 60.0 volume % or less and a content ratio of the binder phase is 40.0 volume % or more and 90.0 volume % or less based on 100.0 volume % of the entire cubic boron nitride sintered body,
the binder phase includes a Ti compound phase, an Al compound phase, and a W element-containing phase,
a content ratio of the Ti compound phase is 60.0 volume % or more and 92.0 volume % or less, a content ratio of the Al compound phase is more than 0.0 volume % and less than 15.0 volume %, and a content ratio of the W element-containing phase is 5.0 volume % or more and 30.0 volume % or less based on 100.0 volume % of the entire binder phase,
the W element-containing phase contains at least one selected from the group consisting of W₂B and WB, and
I₂/I₁ is 0.03 or more and 0.60 or less, where I₁ denotes an X-ray diffraction peak intensity of a (111) plane of the cubic boron nitride, and I₂ denotes a sum of X-ray diffraction peak intensities of a (211) plane of W₂B and a (110) plane of WB in the binder phase.

2. The cubic boron nitride sintered body according to claim 1, wherein I₃/I₁ is 0.03 or less, where I₃ denotes an X-ray diffraction peak intensity of a (101) plane of WB₂ in the binder phase.

3. The cubic boron nitride sintered body according to claim 1, wherein I₄/I₂ is 0.50 or more and 0.95 or less, where I₄ denotes an X-ray diffraction peak intensity of a (211) plane of WB₂ in the binder phase.

4. The cubic boron nitride sintered body according to claim 1, wherein an average thickness λ of the W element-containing phase is 0.03 μm or more and 0.12 μm or less.

5. The cubic boron nitride sintered body according to claim 1, wherein
the Ti compound phase contains TiB₂, and
I₅/I₁ is 0.07 or more and 0.55 or less, where I₅ denotes an X-ray diffraction peak intensity of a (101) plane of TiB₂ in the binder phase.

6. The cubic boron nitride sintered body according to claim 1, wherein
the W element-containing phase contains Co element, and
a content ratio of Co element based on a total content ratio of W element and Co element is 5 atom % or more and less than 50 atom % in the W element-containing phase.

7. A coated cubic boron nitride sintered body comprising the cubic boron nitride sintered body according to claim 1 and a coating layer formed on a surface of the cubic boron nitride sintered body, wherein
an average thickness of the entire coating layer is 0.5 μm or more and 6.0 μm or less.

8. The cubic boron nitride sintered body according to claim 2, wherein I₄/I₂ is 0.50 or more and 0.95 or less, where I₄ denotes an X-ray diffraction peak intensity of a (211) plane of WB₂ in the binder phase.

9. The cubic boron nitride sintered body according to claim 2, wherein an average thickness λ of the W element-containing phase is 0.03 μm or more and 0.12 μm or less.

10. The cubic boron nitride sintered body according to claim 3, wherein an average thickness λ of the W element-containing phase is 0.03 μm or more and 0.12 μm or less.

11. The cubic boron nitride sintered body according to claim 8, wherein an average thickness λ of the W element-containing phase is 0.03 μm or more and 0.12 μm or less.

12. The cubic boron nitride sintered body according to claim 2, wherein
the Ti compound phase contains TiB₂, and
I₅/I₁ is 0.07 or more and 0.55 or less, where I₅ denotes an X-ray diffraction peak intensity of a (101) plane of TiB₂ in the binder phase.

13. The cubic boron nitride sintered body according to claim 3, wherein
the Ti compound phase contains TiB₂, and
I₅/I₁ is 0.07 or more and 0.55 or less, where I₅ denotes an X-ray diffraction peak intensity of a (101) plane of TiB₂ in the binder phase.

14. The cubic boron nitride sintered body according to claim 4, wherein
the Ti compound phase contains TiB₂, and
I₅/I₁ is 0.07 or more and 0.55 or less, where I₅ denotes an X-ray diffraction peak intensity of a (101) plane of TiB₂ in the binder phase.

15. The cubic boron nitride sintered body according to claim 8, wherein
the Ti compound phase contains TiB₂, and
I₅/I₁ is 0.07 or more and 0.55 or less, where Is denotes an X-ray diffraction peak intensity of a (101) plane of TiB₂ in the binder phase.

16. The cubic boron nitride sintered body according to claim 9, wherein
the Ti compound phase contains TiB₂, and
I₅/I₁ is 0.07 or more and 0.55 or less, where I₅ denotes an X-ray diffraction peak intensity of a (101) plane of TiB₂ in the binder phase.

17. The cubic boron nitride sintered body according to claim 10, wherein
the Ti compound phase contains TiB₂, and
I₅/I₁ is 0.07 or more and 0.55 or less, where I₅ denotes an X-ray diffraction peak intensity of a (101) plane of TiB₂ in the binder phase.

18. The cubic boron nitride sintered body according to claim 11, wherein
the Ti compound phase contains TiB₂, and
I₅/I₁ is 0.07 or more and 0.55 or less, where I₅ denotes an X-ray diffraction peak intensity of a (101) plane of TiB₂ in the binder phase.

19. The cubic boron nitride sintered body according to claim 2, wherein
the W element-containing phase contains Co element, and
a content ratio of Co element based on a total content ratio of W element and Co element is 5 atom % or more and less than 50 atom % in the W element-containing phase.

20. The cubic boron nitride sintered body according to claim 3, wherein
the W element-containing phase contains Co element, and
a content ratio of Co element based on a total content ratio of W element and Co element is 5 atom % or more and less than 50 atom % in the W element-containing phase.
